(19) United States
(12) Patent Application Publication
(10) Pub. No.: US 2005/0210610 A1
(43) Pub. Date: Sep. 29, 2005

(54) Apparatus and methods for cleaning the components of a feed device

(75) Inventors: Danny Louie, Thousand Oaks, CA (US); Prasanna Prapancham, Camarillo, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/077,237

(22) Filed: Mar. 10, 2005

Related U.S. Application Data
(60) Provisional application No. 60/557,024, filed on Mar. 26, 2004.
(60) Provisional application No. 60/557,273, filed on Mar. 29, 2004.

(51) Int. Cl. A47L 11/02; G03D 5/06; B67C 3/00

(52) U.S. Cl. 15/102

(57) ABSTRACT

Apparatus and associated methods for cleaning a feed device are provided. For example, the present invention may provide a cleaning media for cleaning a printer or other device having a feed path along which cards or other stock media are fed during printing. The cleaning media, which can be used to automatically clean the feed device, can include an identification feature by which the feed device can identify the media. Thus, the feed device can distinguish the cleaning media from a stock media and or an improper cleaning media. The cleaning media can also define a stop portion that prevents the media from being entirely inserted into the feed path of the feed device. Thus, the cleaning media can be held stationary during part of the cleaning operation so that rollers or other moving members along the feed path make sliding contact with the cleaning media. In some cases, the feed device can be cleaned automatically, e.g., according to a predetermined program of operations that also notifies and prompts an operator during and prior to the cleaning operation.

### CROSS-REFERENCE TO RELATED APPLICATIONS

This application claims the benefit of U.S. Provisional Patent Application Ser. No. 60/557,024, filed Mar. 26, 2004; and U.S. Provisional Patent Application Ser. No. 60/557,273, filed Mar. 29, 2004.

### BACKGROUND OF THE INVENTION

1) Field of the Invention

This invention relates to the cleaning of a feed device and, more particularly, to a cleaning media and associated methods for cleaning a feed device such as the head and rollers of a printer.

2) Description of Related Art

Conventional feed devices are used for feeding or transporting stock materials such as plastic cards, paper, and the like. For example, a typical printer defines a feed path along which stock is transported during printing. Rollers are disposed along the feed path and oriented generally perpendicular to the feed direction of the stock. The rollers are typically configured in pairs to define nips for engaging the stock in the feed path so that rotation of the rollers causes the stock to be fed or transported along the path.

It is known that debris such as dust, oil, moisture, ink, and the like can be introduced into the feed path and can interfere with the operation of the feeding or other processing of the stock. For example, if rollers are used to transport the stock through the feed path, the debris can interfere with the frictional engagement between the rollers and the stock. Further, in the case of a printer, the debris can interfere with the operation of the printing mechanism therein. For example, a card printer for thermally printing plastic cards can include a print head that disposes dye onto the cards, a magnetic head that programs a magnetic strip on the card, a smart card contact station with an electrical contact that contacts a conductive pad on the card to communicate with a chip on the card, and/or a lamination mechanism with heat rollers that applies laminates to the surfaces of the card. The operation of the print head, the magnetic head, the smart card contact station, and the lamination mechanism can be compromised by the presence of debris in the printer. Further, the cards are typically relatively slippery, and therefore debris on the cards or the rollers used to transport the cards through the feed path can prevent the rollers from transporting the cards properly.

According to a conventional cleaning operation for the card printer, the cards that are normally fed through the device are substituted with a cleaning card. The cleaning card can be fed through the printer in the conventional manner, and can be similar in size as the stock cards or longer than the stock cards. A typical cleaning card has a plastic core layer that is sandwiched between layers of felt that are soaked with isopropyl alcohol or the like so that the rollers and/or the heads of the printer are cleaned as the cleaning card is fed through the printer. By routinely feeding such a cleaning card through the printer, the feed path can be cleaned to maintain the proper operation of the printer. However, if the cleaning operation is not performed, or is performed with insufficient frequency, the printer will not be kept clean. In some cases, an operator of the printer may neglect the cleaning operation in order to avoid the time or expense associated with the cleaning operation. In addition, while the printer may include a display that prompts the operator regarding the cleaning operation, the prompts can be confusing and frustrating to the user, resulting in additional delay or neglect in cleaning. For example, the operator might use a cleaning card that has already been used, or the operator may perform the cleaning operation using a piece of stock material instead of the cleaning card.

Another problem is that most, if not all, conventional cleaning cards are designed to pass through a printer similar to a normal stock card, while cleaning different components as it goes. In some instances, a single pass of the card may not be enough to sufficiently clean the various components.

Thus, there exists a need for an improved apparatus and methods for cleaning the feed path of a feeding device. The apparatus and methods should provide effective cleaning of the feed path, thereby improving the operation of the device. In addition, the apparatus and methods should not be excessively difficult to implement so that effective cleaning can be easily achieved by the operator.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments, but which are not necessarily drawn to scale, wherein:

FIG. 1 is a plan view illustrating a cleaning media according to one embodiment of the apparatus and methods of the present invention;

FIG. 1A is an elevation view illustrating the cleaning media of FIG. 1; FIG. 1B is a partial elevation view illustrating a cleaning media according to another embodiment of the present invention in which the stop portion of the media has a thickness greater than that of the laminar portion;

FIG. 1C is an elevation view illustrating a cleaning media according to another embodiment of the present invention having a barcode for identification of the media;

FIG. 1D is an elevation view illustrating a cleaning media according to another embodiment of the present invention having alphanumeric symbols for identification of the media;

FIG. 1E is an elevation view illustrating a cleaning media according to another embodiment of the present invention having an RF device for identification of the media;

FIG. 1F is an elevation view illustrating a cleaning media according to another embodiment of the present invention having a magnetic strip for identification of the media;

FIG. 1G is an elevation view illustrating a cleaning media according to another embodiment of the present invention having a conductive contact for identification of the media;

FIG. 1H is an elevation view illustrating a cleaning media according to another embodiment of the present invention having a capacitive or resistive element for identification of the media;

FIG. 1I is an elevation view illustrating a cleaning media according to another embodiment of the present invention having an optical reflector, pattern, or hologram for identification of the media;

FIG. 1J is an elevation view illustrating a cleaning media according to another embodiment of the present invention having an optical pass-through for identification of the media;

FIG. 2 is a section view in elevation illustrating the cleaning media of FIG. 1 disposed in a feed path of a printer for cleaning according to one embodiment of the present invention;

FIG. 3 is a plan view illustrating a cleaning media according to another embodiment of the present invention;

FIG. 4 is a flow chart diagram illustrating the operations associated with cleaning a printer according to one embodiment of the present invention;

FIG. 5 is a schematic view in section illustrating a printer with a bar code reader or optical sensor for detecting indicia or patterns on a cleaning media according to another embodiment of the present invention; and

FIG. 6 is a schematic view in section illustrating a printer with a roll drive and tension-sensing device for detecting an increased thickness of the cleaning media according to yet another embodiment of the present invention.

### DETAILED DESCRIPTION OF THE INVENTION

According to one embodiment of the present invention, there is provided an apparatus and associated methods for cleaning a feed device such as a printer. For example, a cleaning media can be used to automatically clean the feed device. The cleaning media can include an identification feature by which the feed device can identify the cleaning media to assure that a proper cleaning media is used for the cleaning operation. In addition, the cleaning media can define a stop portion by which the media can be held stationary during at least part of the cleaning operation so that rollers or other members along the feed path make sliding contact with the cleaning media, thereby increasing the effectiveness of the cleaning operation. According to another embodiment of the present invention, there is provided a method by which the feed device can be cleaned, e.g., automatically, and in conjunction with a user-friendly interface by which an operator can be notified and prompted during and prior to the cleaning operation.

According to one embodiment, the cleaning media is a card that defines a laminar portion that extends in a longitudinal direction from a leading edge to an opposite end, which can be defined by a stop portion. The laminar portion of the card defines first and second opposite transverse edges and has a width sufficiently narrow so that the laminar portion can at least partially pass through a feed path of a feed device. According to one aspect of the invention, a stop portion of the card has at least one dimension that is greater than the corresponding dimension of the laminar portion and the feed path. Thus, the stop portion is configured to be retained by the feed device while the laminar portion is disposed in the feed path during cleaning, even while the rollers rotate against the card. For example, the stop portion can be wider than both the laminar portion and the feed path.

According to another aspect of the invention, the laminar portion also defines an identification feature configured to identify the cleaning card to the printer. The identification feature can be of any nature for identifying the card as a cleaning card, such as either a physical attribute of the card or data stored on or in the card. For example, the identification feature could be a physical attribute of the card, such as its shape, thickness, material from which it is made, density, color, magnetic resonance, resistive or capacitive characteristics, etc. One example of a physical characteristic is notches in the transverse edges of the card. Another example is holes or transparent portions in the card. Further or alternatively, the card could include indicia thereon to identify the card, such as barcode, text, printed patterns, holograms, magnetic strips, a radio frequency identification (RFID) tag disposed on or in the cleaning card, and the like.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

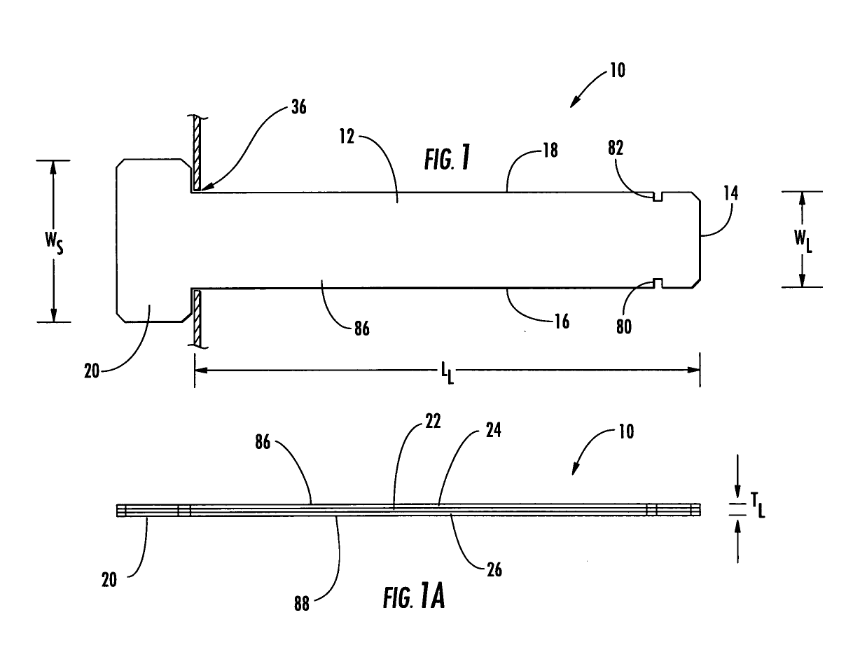

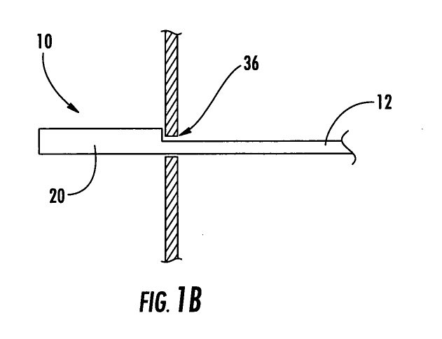

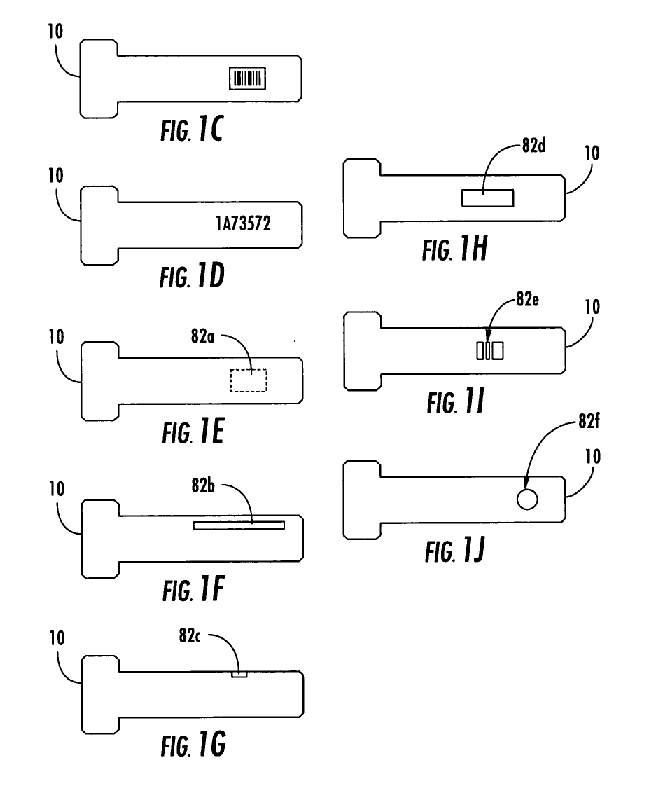

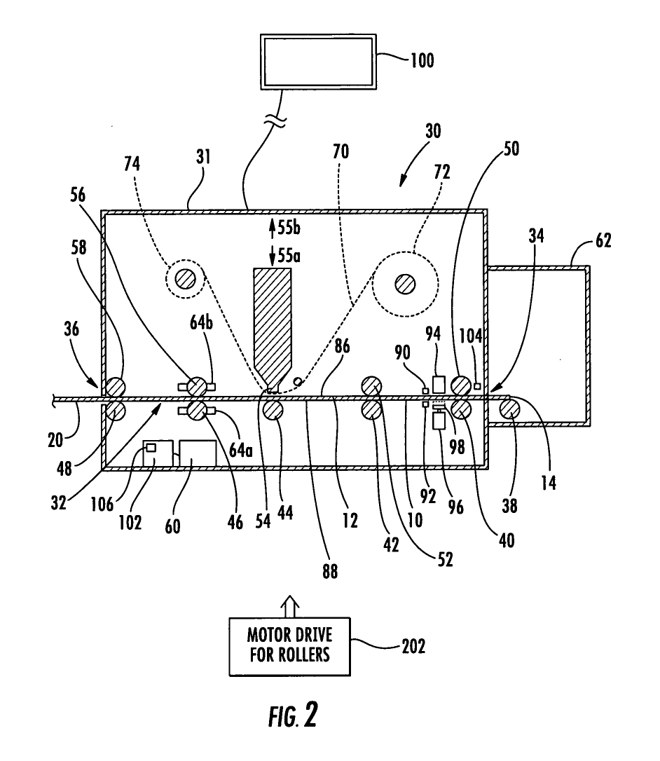

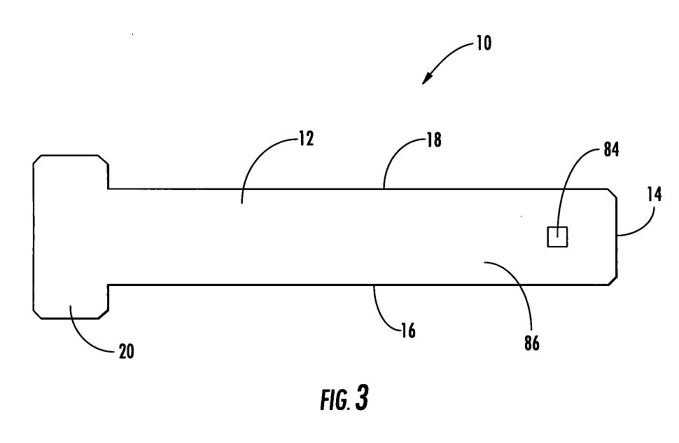

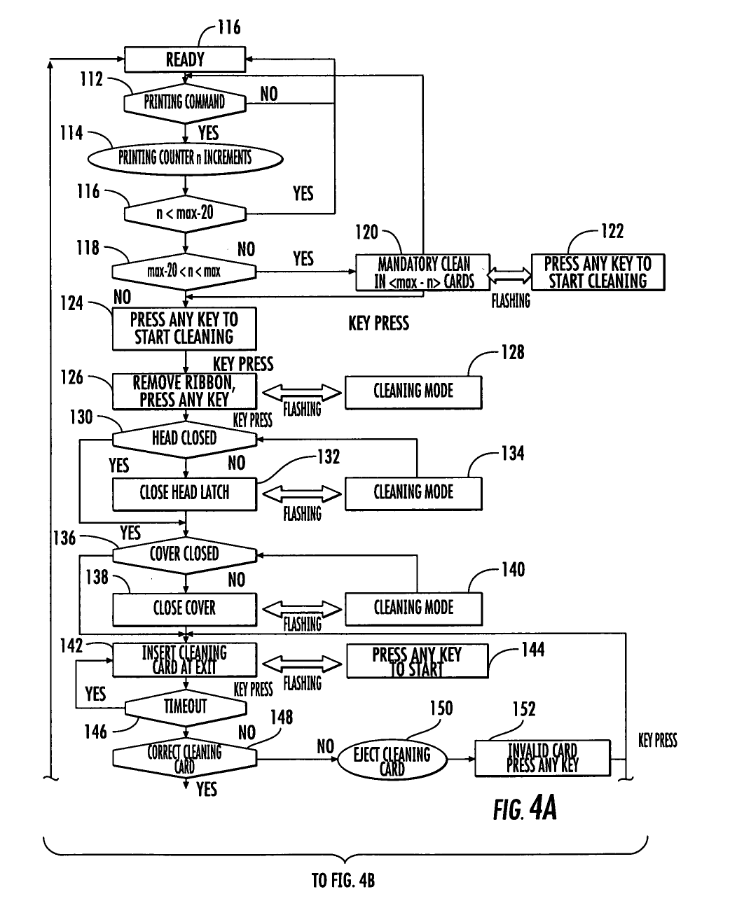

Referring to FIGS. 1 and 1A, there is shown a cleaning media according to one embodiment of the present invention. The cleaning media 10 is generally a laminar sheet of material that can be transported or fed through a feed path 32 of a feed device 30 (FIG. 2). The cleaning media 10 can be formed of a variety of materials and can include special cleaning substances. For example, the media 10 can have a plastic inner core 22 with absorbent layers 24, 26 disposed on opposite sides of the core 22 to define opposite surfaces 86, 88 of the media 10. The absorbent layers 24, 26 can be formed of felt that is soaked with isopropyl alcohol or other cleaning fluids. As illustrated in FIG. 1, the cleaning media 10 defines a laminar portion 12 that extends between a first, or leading, edge 14 of the media 10 to a stop portion 20 of the media 10. The laminar portion 12 of the media 10 is sufficiently thin and narrow that the laminar portion 12 can be inserted through at least part of the feed path 32. For example, the laminar portion 12 can have a thickness T_{L}, as defined between the surfaces 86, 88, and a width W_{L}, as defined between the transverse edges 16, 18, that are about equal to the thickness and width of the stock typically transported through the same feed device that the media 10 is used to clean.

The feed device is described below as a card printer 30, and the cleaning media 10 is described below in conjunction with the cleaning operation of the card printer 30. However, it is appreciated that the cleaning media 10 can alternatively be used to clean other feed devices. For example, the cleaning media 10 can be used to clean the rollers, stationary elements, and other portions of various types of feed devices such as other types of printers, lamination stations and machines, copiers, or transport mechanisms used to feed stock such as paper, cardboard, plastic, metal, and the like. In this regard, the size and material of the cleaning media 10 can be selected according to the dimensions, operating parameters, and cleaning demands of the particular feed device that is to be cleaned with the media 10.

The stop portion 20 of the cleaning media 10 defines at least one dimension that is greater than a corresponding dimension of the feed path 32 and, hence, the laminar portion 12. That is, at least one of the dimensions of the cleaning media 10 is sufficiently large to prevent the passage of the stop portion 20 through the feed path 32. For example, as illustrated in FIG. 1, the stop portion 20 defines a width W_{S} that is greater than the width W_{L} of the laminar portion 12. Moreover, the width Ws of the stop portion 20 can also be greater than width of a space, for example, exit 36, in the feed device 30 along the feed path 32 (FIG. 1). In an alternative configuration, the stop portion 20 could have a thickness that is greater than the laminar portion 12 and a space, for example, exit 36, in the printer feed path 32 FIG. 1B).

FIG. 2 illustrates a feed path 32 defined by a card printer such as the P310i Printer available from Zebra Technologies Corp. The feed path 32, which extends through a housing 31 of the printer 30 from an entrance 34 to an exit 36, defines the path of travel of a piece of stock, such as a plastic card, through the printer 30. Rotatable rollers 38, 40, 42, 44, 46, 48, 50, 52, 56, 58, or other media transport device such as a belt, are provided along the feed path 32, and the rollers 38, 40, 42, 44, 46, 48 are configured to rotate to feed the cards or other media through the printer 30 during operation. For example, lower rollers 38, 40, 42, 44, 46, 48 can mechanically communicate with a rotational driver 60 such as an electric motor. Thus, during normal printing operation of the printer 30, a stack of the cards can be provided in a hopper 62 proximate to the entrance 34 of the feed path 32, and the cards can be individually fed from one side of the stack and then fed along the feed path 32 to the exit 36. The adjacent rollers 38, 40, 42, 44, 46, 48 can be separated by distances less than the length of each stock card so that each stock card is always engaged by at least one of the rollers 38, 40, 42, 44, 46, 48 while being transported through the feed path 32. Further, each of the lower rollers 38, 40, 42, 44, 46, 48 can be configured opposite the feed path 32 from an upper member. For example, as illustrated in FIG. 2, the lower rollers 40, 42, 44, 46, 48 are disposed opposite a cleaning cassette roller 50, an upper roller 52, a head 54, and upper rollers 56, 58, respectively. Thus, the cards are engaged between the lower rollers 40, 42, 44, 46, 48 and the respective upper member 50, 52, 54, 56, 58 so that the rollers frictionally engage the cards. In this regard, the rollers 38, 40, 42, 44, 46, 48, 50, 52, 56, 58 can be formed of a material such as rubber or an elastically deformable polymer so that the rollers 38, 40, 42, 44, 46, 48, 50, 52, 56, 58 can frictionally engage stock such as the cards, which can have smooth surfaces formed of polyvinyl chloride (PVC) or other somewhat slippery materials.

As is known in the printing industry, the head 54 of the card printer 30 can be a device for disposing a dye onto the stock cards. For example, a thermal dye ribbon 70 can extend from a supply spool 72 to a take-up spool 74 with the ribbon 70 disposed between the head 54 and one of the cards in the feed path 32. Dyes of one or more colors are disposed on the ribbon 70, and the head 54 is configured to press the ribbon 70 against the card and/or heat the ribbon 70 at particular locations so that the dye in the particular locations of the ribbon 70 is transferred to the card. Such a thermal printing operation is described, e.g., in U.S. Pat. No. 6,151,037 to Kaufman, et al.; U.S. Pat. No. 5,978,004 to Ehrhardt; and U.S. Pat. No. 5,657,066 to Adams, et al., each of which is assigned to the assignee of the present application, and the contents of each of which are incorporated herein in their entirety by reference.

Thus, as each stock card is fed along the feed path 32 of the printer 30, the head 54 can dispose one or more colors onto the card in a predetermined pattern. In some cases, the ribbon 70 can define repeating frames of panels, each panel having a dye of a different color than the other panels of the same frame. For example, each frame can include panels that are yellow, magenta, and cyan, respectively. The stock cards can be alternately advanced and retracted in opposite directions along the feed path 32 so that each card is fed under the head 54 multiple times, during which the head 54 can print different colors from the different panels of a frame. The ribbon 70 and spools 72, 74 are shown in dashed lines in FIG. 2 to indicate that the ribbon 70 and spools 72, 74 are typically removed from the printer 30 before the cleaning media 10 is inserted into the feed path 32 for the cleaning operation.

The cleaning media 10 is configured to be received at least partially in the feed path 32, and in some cases, the laminar portion 12 of the cleaning media 10 can have a length L_{L} as long as the feed path 32 so that the media 10, when fed through the feed path 32, can be disposed entirely through the path 32. For example, FIG. 2 illustrates the operation of the printer 30 in a cleaning mode in which the cleaning media 10 is disposed in the path 32 with the stop portion 20 proximate to the exit 36 of the feed path 32 and the laminar portion 12 of the media 10 extending from the exit 36 to the entrance 34. In some cases, the length L_{L} of the cleaning media 10 can be 12 inches or greater, depending on the length of the feed path 32 of the device 30 for which the cleaning media 10 is to be used for cleaning. In other embodiments of the present invention, the cleaning media 10 can be configured to be disposed through only a portion of the feed path 32, and/or the cleaning media 10 can be inserted alternatively through the entrance 34 and fed toward the exit 36 in which case the stop portion 20 of cleaning media 10 would engage the housing of entrance 34 rather than exit 36.

As described above, the stop portion 20 of the media 10 is larger in at least one dimension than the feed path 32 so that the stop portion 20 is restrained from entering the feed path 32. For example, as illustrated in FIG. 1, the cleaning media 10 generally defines a T-shape with the stop portion 20 having a width W_{S} that is greater than the width W_{L} of the laminar portion 12 and greater than the width of the feed path 32. Thus, the stop portion 20 of the media 10 does not enter the feed path 32 during the cleaning mode. In other embodiments of the present invention, the stop portion 20 can alternatively be uniformly thicker than the feed path 32, or the stop portion 20 can define one or more areas that are individually thicker than the feed path 32. It is also appreciated that the cleaning media 10 can be formed without the stop portion 20, i.e., so that the entire media 10 is capable of being fed through the feed path 32. In that case, the cleaning media 10 can be unrestrained or can be restrained by a different feature such as a connection between the printer 30 and one end of the cleaning media 10.

According to another embodiment of the invention, the cleaning media 10 can be engaged in the feed path 32 by contact between an adjustable member and the cleaning media 10. For example, a smart card contact 94 can be configured to make electrical contact with a conductive pad on a smart card in the feed path 32. An electromagnetic solenoid 96 can be positioned opposite the feed path 32 from the smart card contact 94 and configured to adjust a cap 98 or plunger against the smart card in the feed passage 32 to urge the smart card against the smart card contact 94. With the cleaning media 10 in the feed path 32, the solenoid 96 can move the cap 98 to an extended position (shown in dashed lines in FIG. 2) so that the cap 98 contacts the cleaning media 10 and urges the cleaning media 10 against the smart card contact 94, thereby securing the media 10 in place and preventing the media 10 from moving, even when the rollers are operated. In addition, or alternative, other members can be positioned to move and engage the cleaning media 10 in the feed path 32 to immobilize the cleaning media 10. For example, the head 54 can be adjustable in a direction generally normal to the feed passage 32, i.e., in directions 55a, 55b. By adjusting the head 54 in direction 55a and urging the cleaning media 10 against the roller 44, the head 54 can restrain the media 10 to prevent movement of the cleaning media 10 during cleaning.

The cleaning media 10 also defines an identification feature, by which the printer 30 can identify the cleaning media 10. For example, as illustrated in FIG. 1, the laminar portion 12 defines notches 80, 82 extending inward from the opposite transverse edges 16, 18. However, it is appreciated that the identification feature can be any characteristic of the cleaning media 10, either a physical characteristic or something located or stored in or on the media 10, and the identification feature can be located anywhere on the media 10. For example, the identification feature can be a barcode (FIG. 1C), alphanumeric symbols or text (FIG. 1D), or other indicia on the cleaning media 10; a portion of the cleaning media 10 that is colored differently than the surrounding area on the cleaning media 10; an electronic article surveillance (ESA) RF resonant security element 82a (FIG. 1E) or magnetic strip 82b (FIG. 1F) disposed on or in the cleaning media 10; a conductive contact (82c (FIG. 1I); a capacitive or resistive element 82d (FIG. 1H); an optical reflector, pattern, or hologram 82e (FIG. 1I); an optical pass-through such as an aperture or transparent window 82f (FIG. 1J); and the like. Further, the identification feature can be a general characteristic of the media 10 such as a geometric dimension of a portion of the media 10 such as a step or other nonuniformity, change, or perturbation in a dimension or configuration of the cleaning media 10; a capacitive, resistive, or inductive quality of the media 10; an optical characteristic of the media 10; and the like. In addition, the identification feature can identify the printer 30 or other device with which the cleaning media 10 is to be used or a printer characteristic or attribute that is compatible with the cleaning media 10.

The identification feature can be detected by the printer 30 in order to distinguish the cleaning media 10 from the stock medias typically printed in the printer 30 and/or to identify the particular cleaning media 10. For example, as shown in FIG. 3, the identification feature is a tag 84 such as an RFID tag or a magnetic strip. The tag 84 can be encoded with data, i.e., by storing the data in a memory of an RFID tag or magnetically encoding the data on a magnetic strip. The data can be read or retrieved by the printer 30, e.g., to identify the cleaning media 10, to detect if the cleaning media 10 has been used before, to detect aspects of the cleaning media 10 such as the type or age of the media 10, and the like. In some cases, the printer 30 can also reject the cleaning media 10 according to the data, such as if the cleaning media 10 is the wrong type of media 10 for the printer 30, is older than a threshold age, has been used before, or is dirty. For example, the tag 84 can include a serial number, counter, or other identification data that is retrieved from the identification feature by the printer 30, e.g., to be used by the printer 30 to control the printer 30 or the cleaning thereof by the cleaning media 10. In the case of a counter stored in the media 10, the printer 30 can store in the counter the number of times that the media 10 has been used. Such a counter is typically part of the media 10, e.g., a memory of the identification feature, but the counter can alternatively be part of the printer 30. In either case, the printer 30 can display data from the counter in order to indicate to the user the remaining number of uses of the media 10, e.g., via a liquid crystal display (LCD) 100. After a predetermined number of uses, the printer 30 can automatically reject the media 10 or inform the operator that the media 10 is no longer effective and needs to be replaced.

Thus, the identification feature can be used to “lock” the media 10 to prevent its use after a predetermined number of uses. Further, in some cases, the printer 30 can lock the media 10 in other ways. For example, the printer 30 can provide an indication of the use of the media 10 by printing a mark on the media 10, by breaking or deforming the media 10 using a physical force or heat, or by otherwise subjecting the media 10 to pressure, heat, light, or the like.

In other embodiments, the printer 30 can alternatively detect whether the media 10 is dirty, regardless of the number of times that the media 10 has been used. That is, the printer 30 can include a detector for detecting the amount of use or remaining life of the media 10, e.g., by detecting cleanliness of the media 10. For example, the printer 30 can include an optical sensor for detecting the amount of lint or other debris on the media 10, the amount of wear or discoloration of the media 10, or other attributes of the media 10 that are indicative of the remaining use of the media 10.

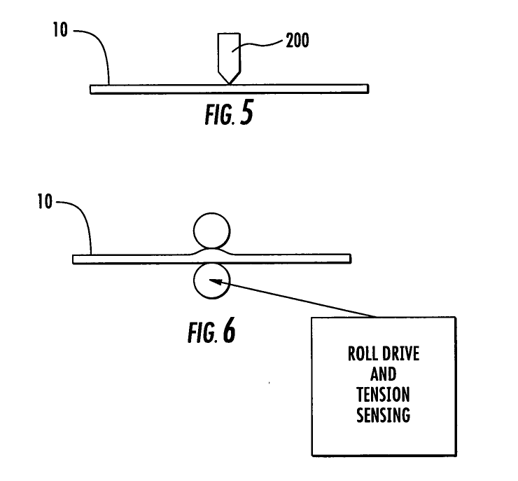

As illustrated in FIG. 1, in another embodiment, notches 80, 82 in the cleaning media 10 could be used to identify the media 10. As described below, in this embodiment, the printer 30 may include a sensor, such as an optical sensor that senses the presence of these notches 80, 82 as the media 10 is inserted or after the media 10 is disposed in the printer 30. The notches 80, 82 may even form a pattern that corresponds to specific data about the cleaning media 10. The media 10 could include a bar code or other indicia or pattern (FIG. 1C). In this instance, the printer 30 would include a bar code reader or optical sensor 200 (FIG. 5) to detect these indicia or patterns. The cleaning media 10 could be designed to have a particular resistance characteristic or a specific capacitive characteristic that could be detected with an appropriate sensor in the printer 30. The cleaning media 10 could have an increased thickness that is detectable by the increases tension on the feed rolls (FIG. 6). The cleaning media 10 could include a magnetic strip that is read by a reader in the printer similar to the system of FIG. 5.

In any case, the identification feature(s) can be disposed symmetrically on the cleaning media 10 so that the cleaning media 10 can be received into the printer 30 in more than one orientation with the identification feature properly oriented. For example, the two notches 80, 82 of the cleaning media 10 illustrated in FIG. 1 are located at corresponding positions on the opposite transverse edges 16, 18 of the media 10. Thus, even if the printer 30 is configured to identify only the one of the notches 80, 82 at one side of media 10, the media 10 can be installed with the transverse edges 16, 18 in opposite positions (i.e., with the media 10 flipped over) so that one of the two notches 80, 82 is detectable by the printer 30. Alternatively, in the case of the cleaning media 10 of FIG. 3, the identification tag 84 can be disposed in the plastic core 22 of the media 10 equidistant from the transverse edges 16, 18 so that the tag 84 is detectable from either of opposite sides of the media 10. Thus, the media 10 can similarly be used in either of opposite (flipped) orientations, i.e., with either of the surfaces 86, 88 directed toward the lower rollers 38, 40, 42, 44, 46, 48. In other embodiments of the invention, the cleaning media 10 can be formed without any identification feature.

According to one method of cleaning the printer 30 illustrated in FIG. 2, the printer 30 is first emptied of any stock media that are being printed. The stock media are typically ejected from the exit 36 of the feed path 32 after being printed. A cleaning mode is then initiated, e.g., automatically by the printer 30 or upon an operator's command. The operator then provides the cleaning media 10 to the exit 36 of the feed path 32 and partially inserts the first edge 14 of the media 10 into the feed path 32 so that the rollers 48, 58 engage the cleaning media 10. Thereafter, the printer 30 can perform the cleaning operation automatically without assistance from the operator. The printer 30 feeds the cleaning media 10 through the feed path 32 toward the entrance 34 so that the identification feature of the media 10 passes proximately to a detector. The detector can be configured to detect the identification feature using an electrical, optical, electromagnetic, RFID, or other mode of detection. For example, in the case of the cleaning media 10 of FIG. 1, the detector can include a light source 90, such as a light emitting diode (LED), and a light-triggered transducer 92 or receiver. The light source 90 and the transducer 92 are disposed on opposite sides of the feed path 32 so that the transducer 92 can detect when the media 10 is disposed in the feed path 32 and blocking the passage of light from the source 90. Thus, as the media 10 is fed through the feed path 32, the first edge 14 of the media 10 passes between the source 90 and transducer 92 and interrupts the passage of light. As the media 10 is further fed along the path 32, one of the notches 80, 82 becomes disposed between the source 90 and transducer 92 so that the passage of light is not interrupted. Then, with further passage of the media 10, the same notch 80, 82 passes beyond the source 90 and transducer 92 so that the media 10 again interrupts the passage of light. These changes in the passage of light are detected, and the printer 30 can determine the size and location of the notch 80, 82 on the media 10, e.g., in order to authenticate the cleaning media 10. In addition, the notch 80, 82 or other identification feature can be transported proximate to the detector at multiple stages of the cleaning operation to verify that the cleaning media 10 is still in the feed path 32. If the detector does not detect the proper cleaning media 10, the printer 30 can halt the cleaning operation and any material in the passage 32 can be rejected. Thus, if the operator starts to perform the cleaning operation with an improper media, such as with a stock card, the printer 30 can automatically stop the operation until the correct cleaning media 10 is provided.

In other embodiments, the detector (previously described as the source 90 and transducer 92) can instead be configured to interact with the identification feature through electromagnetic or magnetic energy. For example, the detector can be a radio frequency interrogation system configured to interrogate a radio frequency identification device on the cleaning media 10. Alternatively, the detector can be an optical reader 200 (FIG. 5) configured to read a bar code of other optical pattern or text or hologram on the cleaning media 10. Further, the detector can be a magnetic reader configured to read a magnetic strip or other information stored magnetically on the cleaning media 10.

The cleaning operation can proceed with multiple stages of operation. In one stage, the rollers 38, 40, 42, 44, 46, 48 can be actuated to advance and retract the cleaning media 10 in opposite directions of the feed path 32 while the head 54 is disposed against the cleaning media 10 so that the cleaning media 10 makes sliding contact with the head 54, thereby cleaning the head 54. In some cases, the head 54 can be adjustably mounted in the printer 30, and can be adjusted toward the roller 44 during at least part of the cleaning operation to achieve sufficient contact between the head 54 and the cleaning media 10. Similarly, other stationary members along the feed path 32 can be cleaned by the passage of the cleaning media 10. For example, the cleaning media 10 can clean a magnetic encoder device 64a, 64b that is used for encoding magnetic strips on the stock media, an optical device that detects features of the media, and the like, each of which can be mounted on the head 54 or elsewhere along the feed path 32. For example, the cleaning media 10 can also clean the smart card contact 94 and/or the electromagnetic solenoid 96 that is positioned opposite the feed path 32 from the smart card contact 94. The devices that are cleaned by the cleaning media 10 can be located on either side of the cleaning media 10. For example, as illustrated, the magnetic encoder device can be located at positions indicated by reference numerals 64a or 64b, though only one magnetic encoder device is typically provided.

Before or after the cleaning of the head 54, a second cleaning stage can be performed to clean the rotating rollers 38, 40, 42, 44, 46, 48, 50, 52, 56, 58. In the second stage, the cleaning media 10 is fed along the feed path 32 until the stop portion 20 of the cleaning media 10 is disposed against the exit of the printer 30, and the stop portion 20 is restrained from entering the feed path 32. The rollers 38, 40, 42, 44, 46, 48 are then rotated in a direction to generally urge the stop portion 20 of the cleaning media 10 into the feed path 32. Thus, the cleaning media 10 remains stationary while the rollers 38, 40, 42, 44, 46, 48 rotate so that the surface of each roller 38, 40, 42, 44, 46, 48 makes sliding contact with the cleaning media 10, thereby cleaning debris from the rollers 38, 40, 42, 44, 46, 48 and onto the cleaning media 10. In other embodiments of the present invention, the upper rollers 50, 52, 56, 58 can also communicate with a rotational driver, such as a motor, so that the upper rollers 50, 52, 56, 58 also rotate against the cleaning media 10. As discussed, the cleaning media 10 may be fed through the feed path 32 in an opposite direction from the direction used to print on the media stock. This is typically done because the exit 30 is more accessible and is not a limitation to the present invention. The cleaning media 10 could be fed in the opposite direction if desired. The motor drive or drives for the rollers is shown schematically in FIG. 2 at 202.

In some embodiments of the invention, the printer 30 can signal or indicate to the operator that the cleaning operation should be performed, e.g., after a predetermined number of printing operations have been performed, at predetermined intervals, when debris is detected in the printer 30, when stock media in the printer 30 is detected by the printer to be dirty, or at other times. For example, the printer 30 can count the number of stock media that are printed, store a value in a memory 106 of the printer that is incremented (or decremented) upon each printing operation, and notify the operator or automatically cease the operation of printing when the count reaches a threshold value such as a minimum or maximum so that the cleaning operation can be performed.

Alternatively, the printer 30 can detect the cleanliness of the stock media passing through the feed path 32, the cleanliness of the cleaning media, the cleanliness of the rollers 38, 40, 42, 44, 46, 48, 50, 52, 56, 58, or the cleanliness of other members of the printer 30 such as the print head 54, e.g., using a detection device 104 such as an optical sensor. The images captured from the detection device could be analyzed to determine the amount of lint, dirt, etc. on the media, rollers, etc. using known defect detection software. For example, there is known software in the semiconductor industry for detecting from captured images flaws in semiconductor wafers. Further, imaging software is used in the papermaking industry to detect flaws in the paper web. Similar, the same software can be adapted in some embodiments of the present invention to determine the cleanliness of the media and/or rollers.

In some cases, the cleaning operation can be performed automatically by the printer 30. In particular, the printer 30 can be configured to feed the cleaning media 10 from a stored position so that the cleaning media 10 is then disposed in the feed path 32. For example, the cleaning media 10 can be stored in a special bin or position so that the printer 30 can retrieve the cleaning media 10 for a cleaning operation, without requiring that the operator provide the cleaning media 10 to a loading position at that time. The bin for the cleaning media 10 can be similar to the hopper 62, but configured to supply the cleaning media 10. Alternatively, in some cases, the cleaning media 10 can be supplied from the same hopper 62 as the stock media that is used for printing. For example, the stock media can be loaded as a pack that includes one or more of the cleaning media 10, i.e., with the cleaning media 10 stacked between a predetermined number of pieces of the stock media so that the cleaning media 10 is received through the feed path 32 after a predetermined number of pieces of the stock media are printed. Further, the printer 30 can include a detector that detects when the cleaning media 10 is being fed through the feed path 32, so that the cleaning operation can be performed accordingly, e.g., by feeding the cleaning media 10 through the feed path 32 multiple times and/or restraining the cleaning media 10 in the feed path 32 (with an adjustable member such as the solenoid 96 or the head 54 as described above or otherwise) while the rollers are rotated against the media 10.

Thus, the printer 30 can automatically perform the cleaning operation, e.g., when the printer 30 determines that the cleaning operation should be performed. As described above, the printer 30 can determine that cleaning should be performed according to a schedule, or when the printer 30 detects dirt or debris in the feed path 32, such as on the rollers 38, 40, 42, 44, 46, 48, 50, 52, 56, 58, the head 54, the stock media, and the like. In this regard, the detector 104 can be configured to monitor the cleanliness of the stock media, the cleaning media 10, the roller 50, or other aspects of the printer 30. In one embodiment, the roller monitored by the detector 104 can be a tacky or sticky roller that is configured to remove debris from the stock media as the stock media passes through the feed path 32. In another embodiment, the detector 104 is configured to monitor the stock media, and the stock media can define a transparent window or other structure and the detector 104 can be configured to direct an optical beam through the window to determine the amount of debris on the stock media and/or the detector 104. Alternatively, a special piece of media having a window can be routinely fed through the feed path 32. Further, in other embodiments, the detector 104 can be positioned elsewhere along the feed path 32, such as proximate to the other rollers or the head 54.

The printer 30 can also be configured to perform the cleaning operation when the printer 30 is being otherwise serviced. For example, printer 30 can be configured to perform the cleaning operation or signal the operator to initiate the cleaning operation at a time such as when the ribbon 70 has been removed from the printer 30. Thus, if the operator removes the ribbon 70 for replacement or for servicing of the other portions of the printer 30, the printer 30 can signal to the operator via the LCD 100 that the cleaning operation should be performed. In this regard, the printer 30 can reduce the number of service operations of the printer 30 by combining the cleaning operation with the other service operations of the printer 30.

In another embodiment, the printer may include an internal clock or counter that marks the amount of time from the last time the printer was cleaned. When the clock or counter reaches a time threshold, the printer can alert the user that the printer should be cleaned, or it may instead instigate an automatic cleaning process as described herein.

In various embodiments of the present invention, the printer 30 can additionally indicate to the operator before the cleaning operation is required. In this regard, the printer 30 can include the LCD 100 as shown in FIG. 2 or another user interface device for signaling to the operator, e.g., for indicating the number of prints performed since the last cleaning operation and indicating when the number of prints since the last cleaning is at least equal to a threshold value. The LCD can be controlled by a controller 102 that also controls the other operations of the printer 30 such as the operation of the rollers 38, 40, 44, 46, 48, the detector, the print head 54, and the like.

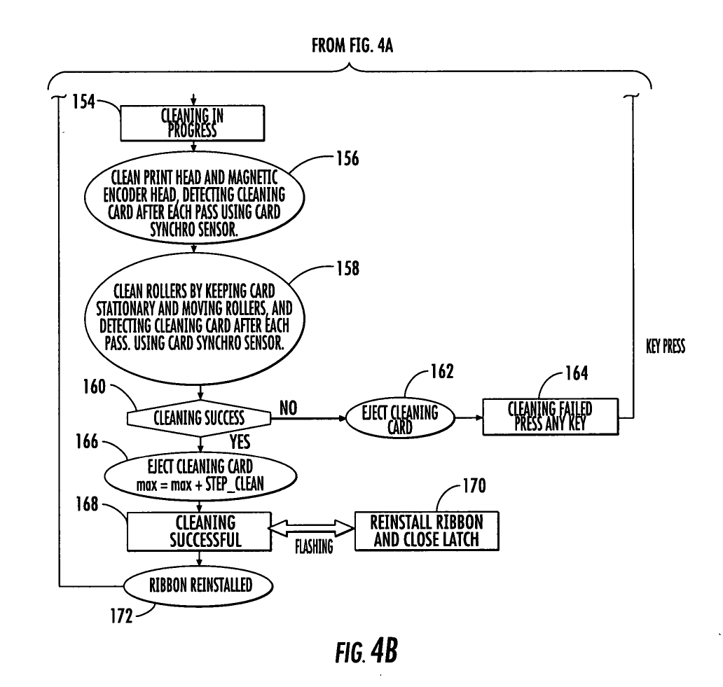

FIG. 4 illustrates the operations for a printer 30 according to one embodiment of the present invention in connection with the cleaning operation of the printer 30. Reference numeral 110 indicates a ready state of the printer 30 in which the printer 30 is ready to receive commands for printing the stock medias. If a printing command is received in Box 112, the printer 30 performs the printing operation and increments a printing counter n, so that the printing counter (n) corresponds to the number of print operations performed since the last cleaning operation. See Box 114. In Box 116, the printer 30 checks to see if the number of print operations (n) is within a predetermined interval of a maximum, e.g., if the number of print operations (n) is less than a maximum (max) minus 20. If so, the cleaning operation does not need to be performed and the printer 30 returns to the ready state of Box 110 to await a printing command. However, if the number of print operations (n) is within the interval, the printer 30 next checks if the number of print operations (n) is within the interval but less than the maximum, i.e., if (max)−20<(n) and (n)<(max). If so, the printer 30 displays prompts on the LCD 100 to alert the operator of the impending requirement for the cleaning operation. For example, the LCD 100 can alternately flash a first message that indicates that a mandatory clean will occur after a specified number of cards are printed (see Box 120) and a second message that prompts the operator to press a key to start cleaning (see Box 122). Thereafter, if the operator presses a key on a keypad of the printer 30, or if the number of printing operations (n) was not less than the maximum (max) in Box 118, the printer 30 displays a message on the LCD 100 requesting the operator to press a key to start the cleaning operation. See Box 124.

After the operator presses a key on the keypad, the operator is prompted with a first flashing message to remove the ribbon and press a key and a second message indicating that the printer 30 is in the cleaning mode. See Boxes 126, 128. In Box 130, the printer detects whether a latch for closing the head, i.e., adjusting the head toward the roller 44, is closed. If the latch is not closed, the operator is prompted with flashing messages indicating that the operator should close the head latch (see Box 132) and that the printer 30 is in the cleaning mode (see Box 134). At which time the head latch is closed, the printer 30 next detects whether a housing cover of the printer 30 is closed. See Box 136. If the cover is not closed, the operator is prompted with flashing messages indicating that the operator should close the cover (see Box 138) and that the printer 30 is in the cleaning mode (see Box 140). At which time the cover is closed, the printer 30 prompts the operator with messages indicating that the operator should insert the cleaning media 10 at the exit 36 (see Box 142) and then press any key to start (see Box 144).

When a key is pressed on the keypad, the printer 30 begins to rotate the rollers 40, 42, 44, 46, 48 in a direction for feeding the cleaning media 10 through the feed path 32 toward the entrance 34, i.e., in a clockwise direction as shown in FIG. 2. Thus, when the operator inserts the media 10 into the exit 36, the media 10 is received between the rollers 48, 58 and the rollers 48, 58 engage the media 10 and transport the media 10 toward the exit 34, i.e., toward the right as illustrated in FIG. 2. The media 10 is successively engaged by the other rollers 40, 42, 44, 46, 50, 52, 56 as the media 10 is transported through the feed path 32. After a predetermined time that is sufficient for the media 10 to have been transported through the feed path 32, i.e., when a timeout condition is met in Box 146, the rollers 40, 42, 44, 46, 48 stop rotating.

Next, the printer 30 determines if the correct cleaning media 10 has been inserted. For example, the rollers 40, 42, 44, 46, 48 of the printer 30 can be used to feed the media 10 through the feed path 32 in one or both directions while the detector of the printer 30 checks the identification feature of the media 30 to determine if the media is correct. See Box 148. If the media is not correct, or if no media has been inserted and fed through the feed path 32, any media that is disposed in the path 32 is ejected from the exit 36 (see Box 150), and the operator is notified by the LCD 100 that the media is invalid and prompted to press a key (see Box 152), then returned to Box 142 to be prompted to insert a cleaning media.

However, if the cleaning media 10 is determined to be correct in Box 148, the operator is notified via the LCD 100 that cleaning is in progress. See Box 154. The cleaning operation then proceeds as described above. For example, in a first stage of the cleaning operation, the cleaning media 10 can be fed through the feed path 32 in alternate directions, e.g., advanced and retracted five or more times, to clean the head 54. During each successive motion of the cleaning media 10, the identification feature can be fed proximate to the detector so that the printer 30 can verify that the correct media 10 is still in the feed path 32. In some embodiments of the present invention, the detector may be able to verify the cleaning media 10 even when the media 10 is not disposed proximate to the detector. See Box 156. In a second stage of the cleaning operation, the rollers 38, 40, 42, 44, 46, 48, 50, 52, 56, 58 of the printer 30 are cleaned by keeping the media 10 stationary and rotating at least some of the rollers 38, 40, 42, 44, 46, 48, 50, 52, 56, 58. For example, the media 10 can be fed through the feed path 32 so that the stop portion 20 is disposed at the exit 36 and physically restrained from entering the feed path 32. The rollers 38, 40, 42, 44, 46, 48 then continue to rotate to make sliding contact with the media 10. In some cases, the rollers 38, 40, 42, 44, 46, 48 can alternately rotate in the opposite direction so that the media 10 is partially ejected from the exit 36 before advancing the stop portion 20 to the exit 36 again and sliding the rollers 38, 40, 42, 44, 46, 48 on the media 10. The identification feature can be detected during the second stage of the cleaning operation, e.g., by feeding the identification feature past the detector. See Box 158. If the identification feature is an RFID tag, registration of the media 10 may be unnecessary, and the RFID tag may not need to be moved into proximity to the detector.

At the conclusion of the cleaning operation, the printer 30 determines if the cleaning operation was performed successfully. See Box 160. If not, the cleaning media 10 is ejected (see Box 162), and the operator is notified that the cleaning operation failed and prompted to press a key (see Box 164), thereafter being returned to Box 142. If the cleaning operation was successful, the cleaning media 10 is ejected and the maximum value (max) is incremented by a predetermined value (step_clean) equal to the number of printing operations that can be performed before the next cleaning operation is to be performed. See Box 166. Of course, if the counter is configured to be incremented upon each printing operation, the counter can be reset to zero upon a successful cleaning operation. In either case, a data log can be maintained in the memory 106 of the printer, e.g., to count the number of times the printer has been cleaned, the number of prints made between one or more cleanings, a schedule of the timing and/or counts of printing and cleaning operations, and the like.

The operator is notified via the LCD 100 that the cleaning was successful (see Box 168) and prompted to reinstall the ribbon 70 and close the latch (see Box 170). When the ribbon 70 is reinstalled and the latch is closed, the printer 30 returns to the ready mode of Box 110 to await a printing command for continued operation.

It is appreciated that the cleaning operation described above can additionally be performed in conjunction with other operations for cleaning or maintaining the cleanliness of the printer 30. For example, U.S. Pat. Nos. 6,285,845 and 6,408,151 describe card cleaning devices that include a cleaning roller with a sticky silicone material that removes undesirable pollutants, such as dust particles, deposited on the printable surface of the stock cards. The entire contents of each of U.S. Pat. Nos. 6,285,845 and 6,408,151 are incorporated herein in their entirety by reference. In one embodiment of the present invention, the cleaning operation described above can be performed in conjunction with the use of such a sticky roller, such as the roller 50 that is part of a cleaning cassette. Thus, the cleanliness of the feed path 32 can be maintained by the combination of the use of the sticky roller 50 and the cleaning operation using the cleaning media 10. In some cases, the cleaning media 10 can be used to clean the sticky roller 50 during the cleaning operation so that debris collected on the sticky roller 50 is then removed from the printer 30 with the cleaning media 10.

The system may also include a sensor that monitors the amount of lint and dust removed by the sticky roller from the media. This is a good indication of the type of environment in which the printer is operated. Using this information, the printer can determine how often the printer should be cleaned.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A cleaning media configured to be inserted at least partially along a stock feed path of a printer to thereby clean portions of the printer, said cleaning media defining an identification feature configured to provide an identification to the printer of said cleaning media.

2. A cleaning media according to claim 1 wherein the identification feature comprises a physical attribute of the cleaning media.

3. A cleaning media according to claim 2 wherein the physical attribute comprises at least one optical pass-through in said cleaning media.

4. A cleaning media according to claim 3 wherein the physical attribute comprises two of the optical pass-throughs, the optical pass-throughs being disposed in a symmetric configuration on cleaning media such that the media is configured to be inserted into the printer in at least two orientations.

5. A cleaning media according to claim 2 wherein the physical attribute comprises a nonuniform dimension of the cleaning media.

6. A cleaning media according to claim 1 wherein the identification feature identifies at least one of the cleaning media and an attribute of the cleaning media.

7. A cleaning media according to claim 2 wherein the identification feature comprises a nonuniform optical characteristic of the cleaning media.

8. A cleaning media according to claim 1 wherein the identification feature is configured to communicate information contained on the cleaning media using at least one of the group consisting of electromagnetic and magnetic energy.

9. A cleaning media according to claim 8 wherein the identification feature comprises at least one of a bar code, printed indicia, magnetic strip, and hologram.

10. A cleaning media according to claim 8 wherein the identification feature is a radio frequency identification tag.

11. A cleaning media according to claim 1 wherein the identification feature identifies at least one of a printer and a characteristic of a printer with which the cleaning media is intended to be used.

12. A cleaning media according to claim 1 wherein the identification feature indicates if the cleaning media has been used before.

13. A cleaning media according to claim 12 wherein the identification feature provides a counter indicating at least one of the group consisting of a number of times that the media has been used and a remaining number of uses of the cleaning media.

14. A cleaning media according to claim 1 wherein the media defines a first portion extending in a longitudinal direction from a leading edge to a stop portion, the first portion defining a width in a transverse direction between the transverse edges configured to pass through at least a portion of the feed path, wherein the stop portion defines a dimension greater than the first portion and the feed path such that the stop portion is configured to be retained by the device while at least part of the first portion is disposed in the feed path.

15. A printing system configured to detect an identification of a cleaning media provided by an identification feature on the cleaning media, when the cleaning media is inserted into said cleaning system.

16. A printing system according to claim 15 wherein the printing system is configured to distinguish the cleaning media from stock media for printing by the system.

17. A printing system according to claim 15 wherein the system is configured to detect a physical attribute of the cleaning media for identification thereof.

18. A printing system according to claim 15 wherein the system is configured to detect from the identification feature an identification of an attribute of the cleaning media.

19. A printing system according to claim 15 wherein the system is configured to communicate information contained on the cleaning media using at least one of the group consisting of electromagnetic and magnetic energy.

20. A printing system according to claim 15 wherein the system is configured to detect at least one of a bar code, printed indicia, and hologram.

21. A printing system according to claim 15 wherein the system is configured to communicate with a radio frequency identification tag of the cleaning media.

22. A printing system according to claim 15 wherein the system is configured to detect information stored magnetically on the cleaning media.

23. A printing system according to claim 15 wherein the system is configured to accept and reject the cleaning media according to the identification feature.

24. A printing system according to claim 15 wherein the system is configured to determine if the cleaning media has been used before according to the identification feature.

25. A printing system according to claim 15 wherein the system is configured to store a value in a counter of the cleaning media indicative of at least one of the group consisting of a number of times that the media has been used and a remaining number of uses of the cleaning media.

26. A printing system according to claim 15 wherein the system is configured to lock the cleaning media to prevent subsequent use of the cleaning media for a cleaning operation.

27. A printing system according to claim 15 wherein the system is configured to use the information from the cleaning media to control the cleaning of the printing system by the cleaning media.

28. A printing system according to claim 15 wherein the printing system includes at least one movable member that is configured to be moved against the cleaning media, the printing system being configured to immobilize the cleaning media in the printing system during a cleaning operation of the printing system by the cleaning media and move the movable member against the cleaning media to clean the movable member.

29. A printing system according to claim 15 further comprising a counter for counting the number of prints made by said system since the system was last cleaned.

30. A printing system according to claim 29, wherein said printing system provides an indication when the number of prints since the last cleaning is at least equal to a threshold.

31. A printing system according to claim 29, wherein said printing system resets said counter when the printing system is cleaned.

32. A printing system according to claim 18, wherein said printing system comprises a memory containing a data log comprising the number of times the printing system has been cleaned.

33. A printing system according to claim 18, wherein said printing system comprises a memory containing a data log comprising the number prints made by the printing system between one or more cleanings.

34. A method of cleaning a printer along a stock feed path thereof, the method comprising:
detecting an identification feature associated with a cleaning media disposed in the feed path of the printer; and
cleaning the printer along the feed path with the cleaning media.

35. A method according to claim 34 wherein said detecting step comprises detecting a physical attribute of the cleaning media.

36. A method according to claim 34 further comprising distinguishing the cleaning media from stock media for printing according to the identification feature detected by the printer.

37. A method according to claim 34 wherein said detecting step comprises transmitting optical energy toward the cleaning media and detecting the passage of the optical energy therethrough.

38. A method according to claim 34 wherein said detecting step comprises detecting a nonuniform dimension of the cleaning media.

39. A method according to claim 34 wherein said detecting step comprises detecting an optical characteristic of the cleaning media.

40. A method according to claim 34 wherein said detecting step comprises communicating information contained on the cleaning media using at least one of the group consisting of electromagnetic and magnetic energy.

41. A method according to claim 34 wherein said detecting step comprises detecting at least one of a bar code, printed indicia, and hologram.

42. A method according to claim 34 wherein said detecting step comprises communicating with a radio frequency identification tag of the cleaning media.

43. A method according to claim 34 wherein said detecting step comprises detecting information stored magnetically on the cleaning media.

44. A method according to claim 34 further comprising rejecting the cleaning media according to the identification feature of the cleaning media.

45. A method according to claim 34 further comprising storing a value in a counter of the cleaning media indicative of at least one of the group consisting of a number of times that the media has been used and a remaining number of uses of the cleaning media.

46. A method according to claim 34 further comprising controlling the cleaning of the printer according to the information detected from the cleaning media.

47. A method according to claim 34 wherein said cleaning step comprises immobilizing the cleaning media in the printer and moving at least one movable member of the printer against the cleaning media while the cleaning media is immobilized in the printer.

48. A method according to claim 34 wherein said immobilizing step comprises advancing the cleaning media into the feed path of the printer until a stop portion of the cleaning media engages the printer to retain the cleaning media in a stationary position and wherein said wherein said moving step comprises rotating the movable member such that the movable member makes sliding contact with the cleaning media.

49. A method according to claim 34 further comprising counting the number of prints made by said system since the system was last cleaned.

50. A method according to claim 49 further comprising providing an indication when the number of prints since the last cleaning is at least equal to a threshold.

51. A method according to claim 49 further comprising resetting the counter when the printing system is cleaned.

52. A method according to claim 49 further comprising storing a data log in a memory where the data log comprises the number of times the printing system has been cleaned.

53. A method according to claim 49 further comprising storing a data log in a memory where the data log comprises the number prints made by the printing system between one or more cleanings.

54. A printer configured to determine the number of prints performed since a cleaning operation has been performed to clean a feed path of the printer.

55. A printer according to claim 54 wherein the printer is configured to detect an identification feature of a cleaning media that is disposed in the feed path of the printer for cleaning the printer.

56. A printer according to claim 55 wherein the printer is configured to distinguish the cleaning media from stock media for printing according to the identification feature detected by the printer.

57. A printer according to claim 54 wherein the printer comprises a detector configured to communicate with the identification feature using at least one of the group consisting of electromagnetic and magnetic energy.

58. A printer according to claim 54 wherein the printer comprises a memory, the printer being configured to adjust a counter stored in the memory according to the number of times that the printer is used to perform a printer operation and the number of times that the cleaning media is used to clean the printer.

59. A printer according to claim 54 wherein the printer comprises a display, the printer being configured to provide an indication via the display indicative of when the number of prints since the last cleaning is at least equal to a threshold.
